(19) United States
(12) Patent Application Publication
(10) Pub. No.: US 2021/0172191 A1
(43) Pub. Date: Jun. 10, 2021

(54) NUT CLIPS FOR ATTACHING OBJECTS TO A POLE

(71) Applicant: Allpole, LLC, Copley, OH (US)

(72) Inventor: Harri RAUMA, Langley (CA)

(73) Assignee: Allpole, LLC, Copley, OH (US)

(21) Appl. No.: 17/110,118

(22) Filed: Dec. 2, 2020

Related U.S. Application Data
(60) Provisional application No. 62/945,573, filed on Dec. 9, 2019.

(51) Int. Cl. E04H 12/00; F16B 2/24

(52) U.S. Cl. CPC E04H 12/003; F16B 2/245

(57) ABSTRACT

Described herein is a clip for connecting an access cover to a pole. The clip may comprise a plate, a lip, and a spring arm. The plate will comprise a first surface, a second surface opposite the first surface, a first edge, and a second edge opposite the first edge. The lip will extend from the first surface of the clip at the first edge, and may comprise a threaded hole. The spring arm will extend from the second surface at the second edge, and may comprise a proximal end, a mid-section, and a bowed distal end. The proximal end will be attached to the second surface at the second edge while the mid-section will be attached to and extend from the proximal end, and the bowed distal end will be attached to and extend from the mid-section. The clip may be manufactured of a material having an elastic modulus (E) in the range of between 150 to 300 GPa.

### CROSS REFERENCES AND PRIORITIES

This application claims priority from U.S. Provisional Application No. 62/945,573 filed on 9 Dec. 2019, the teachings of which are incorporated by reference herein in their entirety.

### BACKGROUND

Poles—including utility poles, light poles, architectural poles, and load bearing poles for displaying signage—are often fabricated with a hollow interior through which various elements, such as wiring, may be routed. These poles will often include one or more access holes through which a user may access the internal elements of the pole during installation, repair, and maintenance.

Such access holes usually include a removable access cover to prevent foreign material such as rainwater, dirt, and debris from entering the internal sections of the pole during normal use—and to deter people from tampering with the internal elements of the pole. Traditionally, the access hole includes a flange welded to the inner and/or outer surface of the pole at the access hole. For reasons of structural integrity, the volume of material which makes up the flange should equal or exceed the volume of material removed from the sidewall of the pole in order to form the corresponding access hole.

This flange may include one or more studs attached to the flange. Each stud includes a threaded connection hole into which a fastener (such as a bolt) for connecting the access cover may pass. Traditionally these studs are welded to the flange after the flange has been welded to the access hole. This process can become time consuming and labor intensive as the stud must be welded to the flange in precisely the correct location so that the threaded connection hole(s) are properly aligned with mounting hole(s) in the access cover.

In addition, the threaded connection hole will often deform during the process of welding. When this happens the threads in the threaded connection hole will have to be repaired prior to installing the access cover. Additional thread repairs may also be needed after the pole has been subjected to a surface treatment, such as galvanizing.

Poles will often include a removable pole top. When used, the removable pole top serves as a cover which prevents foreign material such as rainwater, dirt, and debris from entering the internal sections of the pole during normal use. Traditionally, the pole will include one or more threaded connection holes at the top edge of the pole into which a fastener (such as a bolt) for connecting the removable pole top may pass.

These threaded connection hole(s) will often deform during the process of manufacturing the pole, requiring repair prior to installation. Additional thread repairs may also be needed after the pole has been subjected to a surface treatment, such as galvanizing.

The need exists, therefore, for an improved apparatus and method for attaching an access cover to a pole. The need also exists for an improved apparatus and method for attaching a pole top to a pole.

### SUMMARY

A clip for connecting an access cover to a pole is disclosed. The clip may comprise a plate, a lip, and a spring arm. The plate may comprise a first surface, a second surface opposite the first surface, a first edge, and a second edge opposite the first edge. The lip may extend from the first surface at the first edge, and may comprise a threaded hole. The spring arm may extend from the second surface at the second edge. The spring arm may comprise a proximal end, a mid-section, and a bowed distal end. The proximal end may be attached to the second surface of the plate at the second edge of the plate. The mid-section may be attached to and extend from the proximal end. The bowed distal end may be attached to and extend from the mid-section. The clip may be manufactured of a material having an elastic modulus (E) in a range of between 150 to 300 GPa.

In some embodiments, a first juncture angle between the proximal end and the plate may be in a range selected from the group consisting of between 80° and 100°, between 85° and 95°, and between 89° and 91°.

In some embodiments, a second juncture angle between the mid-section and the proximal end may be in a range selected from the group consisting of between 25° and 75°, between 35° and 65°, and between 45° and 55°.

In some embodiments, a third juncture angle between the bowed distal end and the mid-section may be in a range selected from the group consisting of between 45° and 135°, between 60° and 120°, and between 75° and 105°.

In some embodiments, a fourth juncture angle between the plate and the lip may be in a range selected from the group consisting of between 80° and 100°, between 85° and 95°, and between 89° and 91°.

In certain embodiments, the clip may further comprise a slot. When present, the slot may originate at the bowed distal end, extend through a first juncture between the bowed distal end and the mid-section, and extend into at least a portion of the mid-section. In some embodiments, the slot may extend through a length of the mid-section, through a second juncture between the mid-section and the proximal end, and extend into at least a portion of the proximal end. In some embodiments, the slot may extend through a length of the proximal end, through a third juncture between the proximal end and the plate, and extend into at least a portion of the plate.

In some embodiments, the threaded hole may be formed by applying threads directly to a hole in the lip. Alternatively, the threaded hole may be formed by placing a hole in the lip, and attaching a nut to the lip wherein a first central axis of the nut is substantially aligned with a second central access of the hole. The nut may be attached to the lip by welding or by an adhesive.

In some embodiments, the clip may comprise a centering line running through a central axis of the threaded hole substantially parallel to a length of the clip.

In some embodiments, the second surface of the plate and/or a surface of the spring arm opposite the second surface of the plate may comprise a surface modification. When present, the surface modification may be selected from the group consisting of a burred surface, a grooved surface, a dimpled surface, and combinations thereof.

A clip for connecting a pole top to a pole is also disclosed. The clip may comprise a plate and a spring arm. The plate may comprise a first surface, a second surface opposite the first surface, a first edge, and a second edge opposite the first edge. The plate may also comprise a threaded hole. The spring arm may extend from the second surface of the plate at the second edge. The spring arm may comprise a proximal end which is attached to the second surface at the second edge, a mid-section attached to and extending from the proximal end, and a bowed distal end attached to and extending from the mid-section. The clip may be manufactured of a material having an elastic modulus (E) in a range of between 150 to 300 GPa.

In some embodiments, a first juncture angle (θ₁) between the proximal end and the plate may be in a range of between 80° and 100°. In certain embodiments, a second juncture angle (θ₂) between the mid-section and the proximal end may be in a range of between 25° and 100°. In some embodiments, a third juncture angle (θ₃) between the bowed distal end and the mid-section may in a range of between 45° and 135°.

In certain embodiments, the clip may further comprise a slot.

In some embodiments, the threaded hole may be formed by applying threads directly to a hole in the plate. In other embodiments, the threaded hole may be formed by placing a hole in the plate, and attaching a nut to the plate wherein a first central axis of the nut is substantially aligned with a second central access of the hole.

In certain embodiments, the second surface of the plate and/or a surface of the spring arm opposite the second surface of the plate may comprise a surface modification. In some such embodiments the surface modification may be selected from the group consisting of a burred surface, a grooved surface, a dimpled surface, and combinations thereof.

### BRIEF DESCRIPTION OF FIGURES

FIG. 1 is a perspective view of an embodiment of a clip for connecting an access cover to a pole disclosed herein.

FIG. 2 is a side view of the clip shown in FIG. 1.

FIG. 3 is a top view of the clip shown in FIG. 1.

FIG. 4 is a bottom view of the clip shown in FIG. 1.

FIG. 5 is an exploded cross-section view of an access cover installation using the clip shown in FIG. 1.

FIG. 6 is an assembled cross-section view of the access cover installation shown in FIG. 5.

FIG. 7 is a front view of a pole with a flange and two installed clips.

FIG. 8 is a perspective view of an embodiment of a clip for connecting a pole top to a pole disclosed herein.

FIG. 9 is a side view of the clip shown in FIG. 8.

FIG. 10 is an exploded cross-section view of a pole top installation using the clip shown in FIG. 8.

FIG. 11 is an assembled cross-section view of the pole top installation shown in FIG. 10.

### DETAILED DESCRIPTION

Disclosed herein is a clip for connecting an access cover to a pole. Also disclosed herein is a method of installing an access cover onto a pole using the clip. Further described herein is a clip for connecting a pole top to a pole. It is also disclosed herein a method of installing a pole top onto a pole using the clip. As described herein and in the claims, the following numbers refer to the following structures as noted in the Figures.
10 refers to a pole.
11 refers to a thickness (of the pole).
12 refer to an access hole.
14 refers to a flange.
16 refers to a thickness (of the flange).
18 refers to a second centering line.
20 refers to an access cover.
25 refers to a fastener.
30 refers to a pole top.
100 refers to a clip.
110 refers to a plate.
111 refers to a first surface (of the plate).
112 refers to a second surface (of the plate).
113 refers to a first edge (of the plate).
114 refers to a second edge (of the plate).
115 refers to a threaded hole
120 refers to a lip.
125 refers to a threaded hole.
130 refers to a spring arm.
132 refers to a proximal end (of the spring arm).
134 refers to a mid-section (of the spring arm).
136 refers to a bowed distal end (of the spring arm).
138 refers to a slot.
140 refers to a first centering line.
200 refers to a gap (between the second surface of the plate and the bowed distal end).

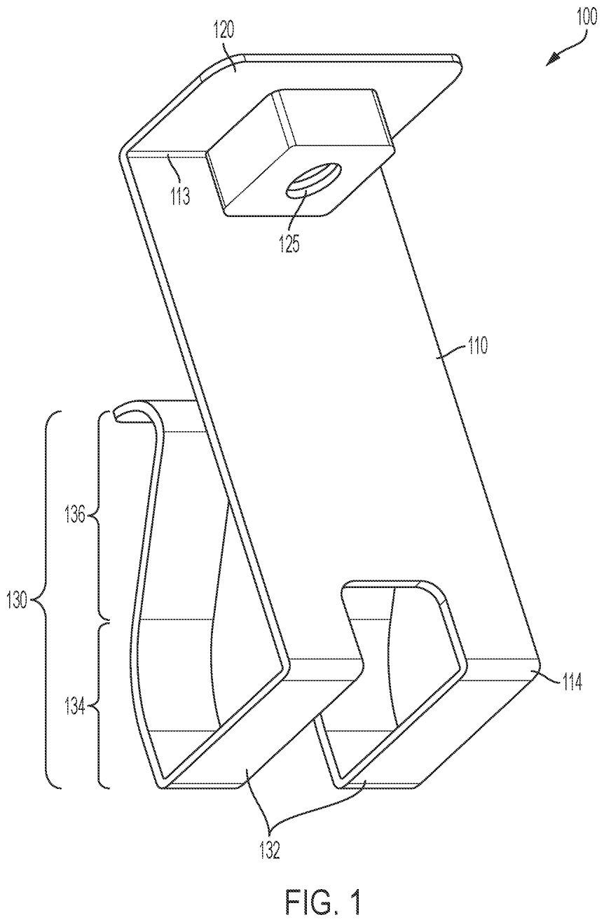

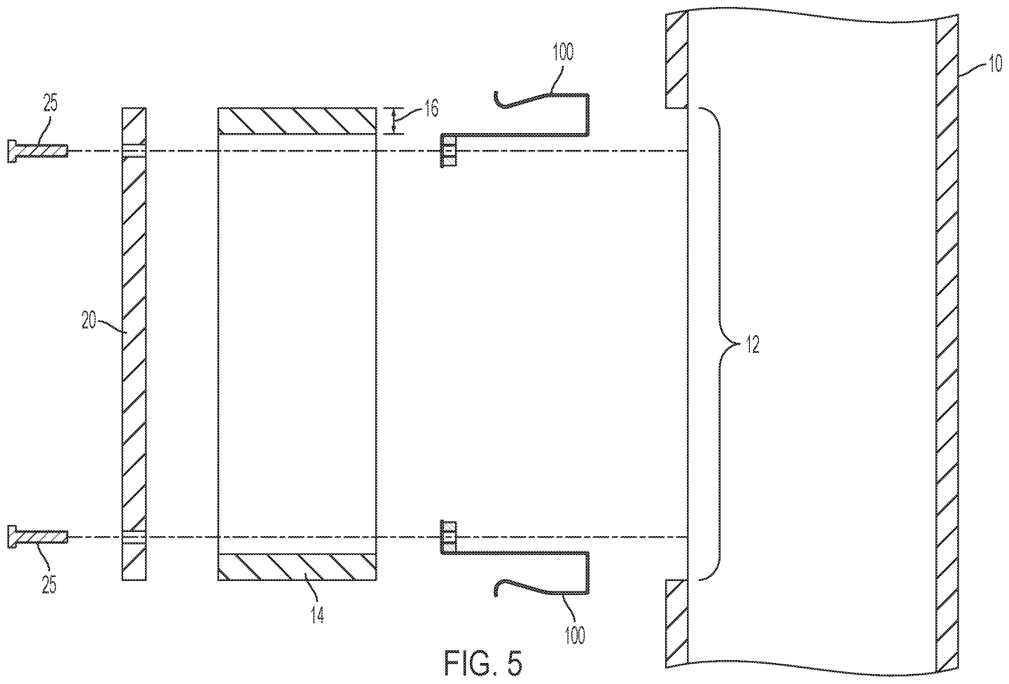

FIG. 1 depicts a perspective view of a clip (100), which may be used for connecting an access cover ((20) as shown in FIG. 5) to a pole ((10) as shown in FIG. 5). As shown in FIG. 1, the clip may comprise a plate (110), a lip (120), and a spring arm (130).

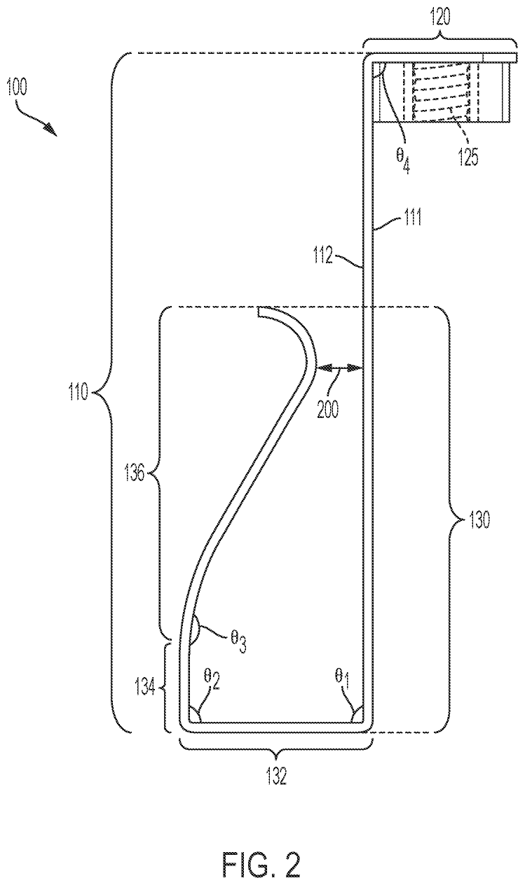

FIG. 2 depicts a side view of the clip (100) shown in FIG. 1. As shown in FIG. 2, the plate (110) may comprise a first surface (111) and a second surface (112) which is opposite of the first surface. The plate may also comprise at least two opposing edges—referred to herein as a first edge ((113) as shown in FIG. 1), and a second edge ((114) as shown in FIG. 1) which is opposite the first edge.

As further shown in FIG. 1 and FIG. 2, the spring arm (130) may extend from the second surface (112) of the plate (110) at the second edge (114). The spring arm may comprise three sections. The first section being a proximal end (132) which may be attached to the second surface at the second edge. The second section being a mid-section (134) which may be attached to and extend from the proximal end. The third section being a bowed distal end (136) which may be attached to and extend from the mid-section.

Preferably the proximal end (132) will extend at a substantially right angle from the plate (110). In this respect, there may be a first juncture angle (θ₁) between the proximal end and the plate. The first juncture angle (θ₁) may be in the range of between 80° and 100° with between 85° and 95° being more preferred, and between 89° and 91° being most preferred.

Preferably the mid-section (134) will extend away from the proximal end (132) and towards the second surface (112) of the plate (110). In this respect, there may be a second juncture angle (θ₂) between the mid-section and the proximal end. The second juncture angle (θ₂) may be in the range of between 25° and 100° with between 35° and 100° being more preferred, and between 45° and 100° being most preferred.

Preferably the bowed distal end (136) will extend away from the mid-section (134) and away from the second surface (112) of the plate (110). In this respect, there may be a third juncture angle (θ₃) between the bowed distal end and the mid-section. The third juncture angle (θ₃) may be in the range of between 45° and 135° with between 60° and 120° being more preferred, and between 75° and 105° being most preferred.

As further shown in FIG. 1 and FIG. 2, the lip (120) may extend from the first surface (111) of the plate (110) at the first edge (113). In this respect, there may be a fourth juncture angle (θ₄) between the plate and the lip. The fourth juncture angle (θ₄) is preferably a right angle or a substantially right angle, but may be in the range of between 80° and 100° with between 85° and 95° being more preferred, and between 89° and 91° being most preferred.

The attachment between the various portions of the clip (such as the lip (120) and the plate (110), or the spring arm (130) and the plate) may take many forms. In the simplest form, the spring arm, the plate, and the lip are manufactured from a single integral piece of material which is bent to have the shape and structure described herein and shown in the Figures. In other embodiments, the spring arm, the plate, and the lip may be manufactured from a single piece of material which is cast or injection molded to have the shape and structure described herein and shown in the Figures. Other embodiments may exist in which one or more portions of the clip are manufactured from separate pieces of material which are subsequently attached to one another, such as by welding, or by a fastener such as a screw, a rivet, or a hinge.

As shown in FIG. 2, there will also be a gap (200) between the second surface (112) of the plate (110) and the bowed distal end (136). In practice this gap should be slightly smaller than the thickness (16) of the flange ((14) as shown in FIG. 5) of the pole ((10) as shown in FIG. 5). By making the gap slightly smaller than the thickness of the flange, the clip (100) can maintain tension around the flange when the clip is installed. By slightly smaller than the thickness of the flange it is meant that the gap is in a range selected from the group consisting of between 1.0 mm and 2.5 cm smaller than the thickness of the flange, between 1.0 mm and 2.0 cm smaller than the thickness of the flange, between 1.0 mm and 1.5 cm smaller than the thickness of the flange, between 1.0 mm and 1.0 cm smaller than the thickness of the flange, between 1.0 mm and 5.0 mm smaller than the thickness of the flange, between 5.0 mm and 2.5 cm smaller than the thickness of the flange, between 5.0 mm and 2.0 cm smaller than the thickness of the flange, between 5.0 mm and 1.5 cm smaller than the thickness of the flange, between 5.0 mm and 1.0 cm smaller than the thickness of the flange, between 1.0 cm and 2.5 cm smaller than the thickness of the flange, between 1.0 cm and 2.0 cm smaller than the thickness of the flange, between 1.0 cm and 1.5 cm smaller than the thickness of the flange, between 1.5 cm and 2.0 cm smaller than the thickness of the flange, and between 2.0 cm and 2.5 cm smaller than the thickness of the flange.

In some embodiments, the second surface (112) of the plate (110) and/or the surface of the spring arm opposite the second surface of the plate may include a surface modification. The preferred surface modifications will increase the friction between the clip (100) and the flange (14) of the pole (10) when the clip is installed, thereby reducing or eliminating the likelihood that the clip will shift or fall off the flange during installation and subsequent use. Specific non-limiting examples of such a surface modification may include a burred surface, a grooved surface, a dimpled surface, and combinations thereof.

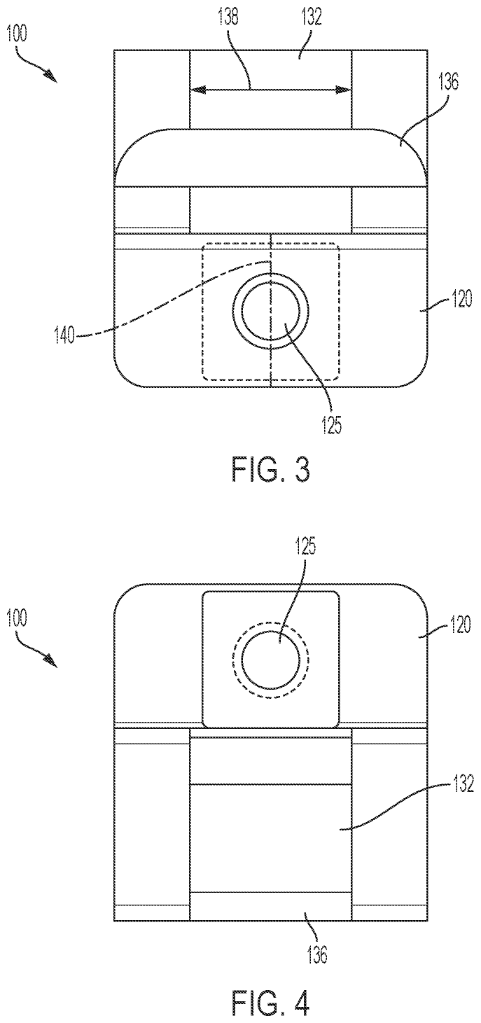

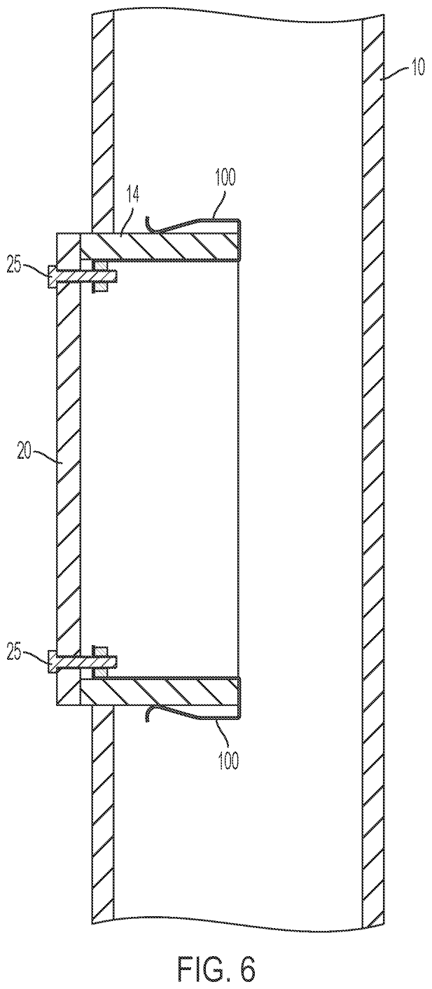

FIG. 3 shows a top view of the clip (100) facing the lip (120). The spring arm (130) is shown in the background in FIG. 3. As shown in FIG. 3, the lip may comprise a threaded hole (125). This threaded hole may be adapted to receive a fastener ((25) as shown in FIG. 5) for connecting the access cover ((20) as shown in FIG. 5) to the pole ((10) as shown in FIG. 5) as shown in FIG. 5 and FIG. 6. The threaded hole may come in many forms. In some embodiments, the lip may be manufactured of a material of sufficient thickness such that threads for the threaded hole may be applied directly to the hole in the lip. In other embodiments, the threaded hole may be formed by placing a non-threaded hole into the lip, and then attaching a threaded nut to a surface of the lip with the central axis of the nut substantially aligned with the central access of the non-threaded hole in the lip. When used, the threaded nut may come in many forms including a square nut and a hex nut, and may be attached to the lip by welding or by an adhesive.

FIG. 4 shows a bottom view of the clip (100) facing the spring arm (130). The lip (120) is shown in the background in FIG. 4. FIG. 4 also shows the spring arm with its bowed distal end (136) extending upwardly from the plate, and its proximal end (132) extending upwardly away from the second surface of the plate.

In some embodiments, the spring arm (130) may include a slot ((138) as shown in FIG. 3). When present, the slot may originate at the bowed distal end (136) of the spring arm. The slot preferably extends through the juncture between the bowed distal end and the mid-section (134) of the spring arm, and into at least a portion of the mid-section. In some embodiments, the slot may only extend into a portion of the length of the mid-section. In other embodiments, the slot may extend through the entire length of the mid-section. In some such embodiments, the slot may also extend through the juncture between the mid-section and the proximal end (132) of the spring arm, and into at least a portion of the proximal end. In some embodiments, the slot may only extend into a portion of the length of the proximal end. In other embodiments, the slot may extend through the entire length of the proximal end. In such embodiments, the slot may also extend through the juncture between the proximal end and the plate (110), and into at least a portion of the plate.

The clip disclosed herein may be manufactured of a variety of materials. Examples of such materials may include metals such as steel, stainless steel, aluminum, copper, or brass. In some embodiments, the clip may be manufactured from a plastic or composite material.

The material from which the clip (100) is manufactured will have an elasticity. One preferred material is spring steel. In this respect the clip may be thought of as a flat spring having an elastic modulus (E) in the range selected from the group consisting of between 150 to 300 GPa, between 150 and 250 GPa, between 150 and 200 GPa, between 175 and 300 GPa, between 175 and 250 GPA, between 175 and 200 GPA, between 200 and 300 GPA, and between 200 and 250 GPA. The material from which the clip is manufactured having such an elasticity allows the clip to maintain tension around the flange (14) of the pole when the clip is installed.

The material from which the clip (100) is manufactured will also have a material thickness. Preferably the material thickness will be in a range selected from the group consisting of between 0.5 mm and 2.0 mm, between 0.5 mm and 1.5 mm, between 0.5 mm and 1.0 mm, between 1.0 mm and 2.0 mm, and between 1.0 mm and 1.5 mm.

FIG. 5 shows an exploded cross-section view of an access cover (20) installation in a pole (10). As shown in FIG. 5, the pole may include at least one access hole (12). Welded to the perimeter of each access hole may be a flange (14). Each flange will have a thickness (16). It is this thickness which is slightly greater than the gap ((200) as shown in FIG. 2) between the second surface ((112) as shown in FIG. 2) of the plate ((110) as shown in FIG. 2) and the bowed distal end ((136) as shown in FIG. 2)—thereby allowing the clip (100) to maintain tension around the flange.

FIG. 6 shows the assembled cross-section view of an access cover (20) installation in a pole (10) of FIG. 5. FIG. 6 shows at least one clip (100) connected to the flange (14). The access cover (20) is shown attached to the clip(s) via fasteners (25) which pass through a hole in the access cover and attach to the threaded hole (125) in the clip. Examples of such fasteners include—but are not limited to—a bolt, a screw, or a rivet.

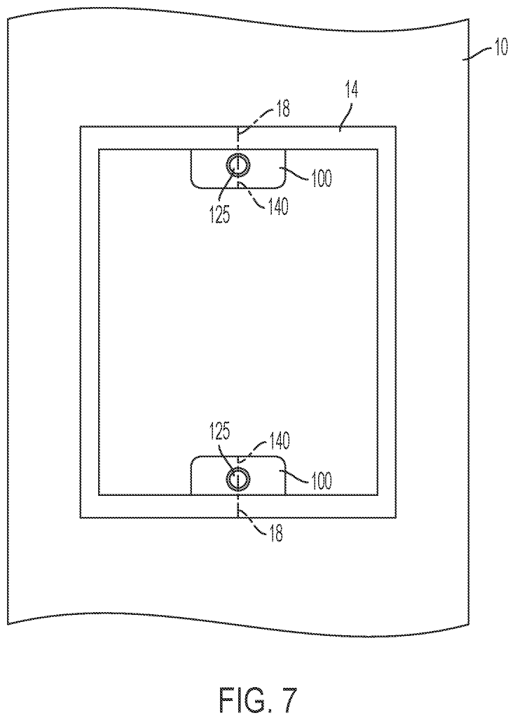

In some embodiments, as shown in FIG. 7, at least one of the clips may include a first centering line (140), and the flange (14) may include one or more second centering lines (18). The first centering line runs through the central axis of the threaded hole substantially parallel to or parallel to the length of the clip as shown in the Figures. Each second centering line is preferably placed upon the internal edge of the flange substantially perpendicular to or perpendicular to the height of the pole as shown in the Figures. Preferably, each centering line will correspond to a location of a hole in the access cover through which a fastener (25) passes to attach to the threaded hole in one of the clips. During installation, the first centering line of each individual clip is aligned with one of the second centering lines, thereby aligning the threaded hole(s) of the fasteners with the holes in the access cover.

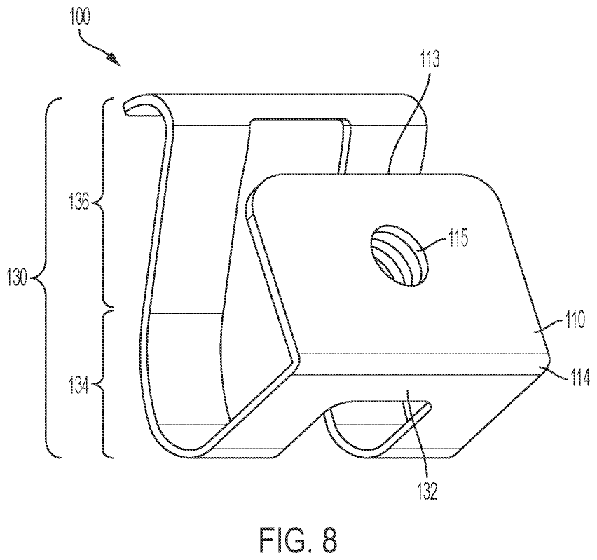

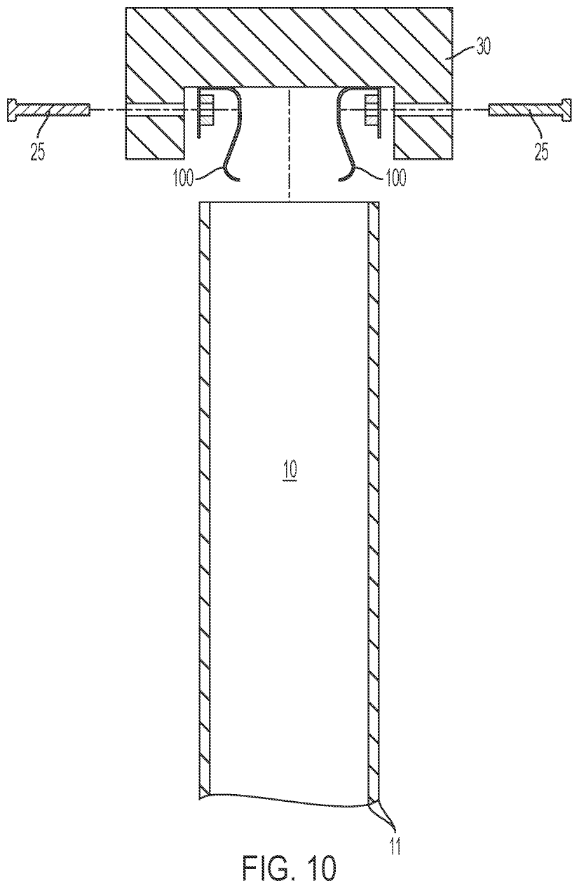

FIG. 8 depicts a perspective view of an alternative clip (100), which may be used for connecting a pole top ((30) as shown in FIG. 10) to a pole ((10) as shown in FIG. 10). As shown in FIG. 8, the clip may comprise a plate (110) and a spring arm (130).

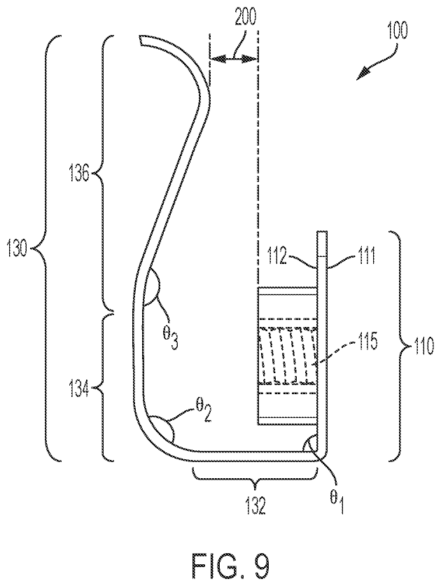

FIG. 9 depicts a side view of the clip (100) shown in FIG. 8. As shown in FIG. 9, the plate (110) may comprise a first surface 9111) and a second surface (112) which is opposite of the first surface. The plate may also comprise at least two opposing edges—referred to herein as a first edge ((113) as shown in FIG. 8), and a second edge ((114) as shown in FIG. 8) which is opposite the first edge.

As further shown in FIG. 8 and FIG. 9, the spring arm (130) may extend from the second surface (112) of the plate (110) at the second edge (114). The spring arm may comprise three sections. The first section being a proximal end (132) which may be attached to the second surface at the second edge. The second section being a mid-section (134) which may be attached to and extend from the proximal end. The third section being a bowed distal end (136) which may be attached to and extend from the mid-section.

Preferably the proximal end (132) will extend at a substantially right angle from the plate (110). In this respect, there may be a first juncture angle (θ₁) between the proximal end and the plate. The first juncture angle (θ₁) may be in the range of between 80° and 100° with between 85° and 95° being more preferred, and between 89° and 91° being most preferred.

Preferably the mid-section (134) will extend away from the proximal end (132) and towards the second surface (112) of the plate (110). In this respect there may be a second juncture angle (θ₂) between the mid-section and the proximal end. The second juncture angle (θ₂) may be in the range of between 25° and 100° with between 35° and 100° being more preferred, and between 45° and 55° being most preferred.

Preferably the bowed distal end (136) will extend away from the mid-section (134) and away from the second surface (112) of the plate (110). In this respect, there may be a third juncture angle (θ₃) between the bowed distal end and the mid-section. The third juncture angle (θ₃) may be in the range of between 45° and 135° with between 60° and 120° being more preferred, and between 75° and 105° being most preferred.

The attachment between the various portions of the clip (such as the plate (110) and the spring arm (130)) may take many forms. In the simplest form, the spring arm and the plate are manufactured from a single integral piece of material which is bent to have the shape and structure described herein and shown in the Figures. In other embodiments, the spring arm and the plate may be manufactured from a single piece of material which is cast or injection molded to have the shape and structure described herein and shown in the Figures. Other embodiments may exist in which one or more portions of the clip are manufactured from separate pieces of material which are subsequently attached to one another, such as by welding, or by a fastener such as a screw, a rivet, or a hinge.

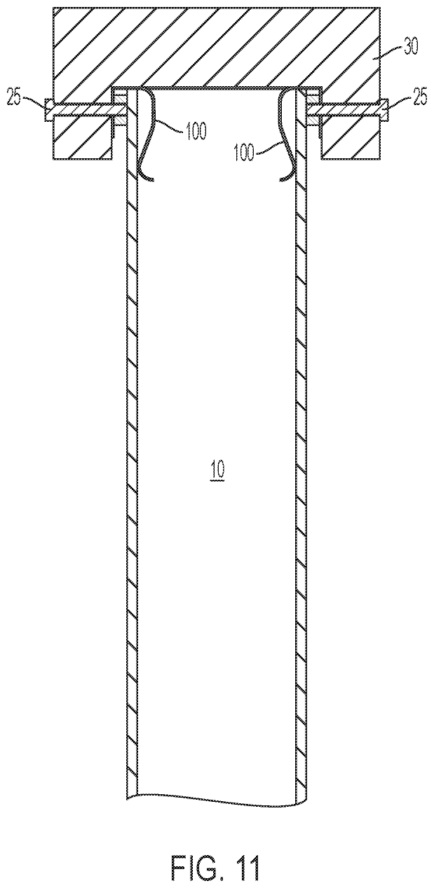

FIG. 8 also shows the plate (110) comprising a threaded hole (115). This threaded hole may be adapted to receive a fastener ((25) as shown in FIG. 10) for connecting the pole top ((30) as shown in FIG. 10) to the pole ((10) as shown in FIG. 10) as shown in FIG. 10 and FIG. 11. The threaded hole may come in many forms. In some embodiments, the plate may be manufactured of a material of sufficient thickness such that threads for the threaded hole may be applied directly to the hole in the plate. In other embodiments, the threaded hole may be formed by placing a non-threaded hole into the plate, and then attaching a threaded nut to a surface of the plate with the central axis of the nut substantially aligned with the central access of the non-threaded hole in the plate. When used, the threaded nut may come in many forms including a square nut and a hex nut, and may be attached to the lip by welding or by an adhesive.

As shown in FIG. 9, there will also be a gap (200) between the second surface (112) of the plate (110) and the bowed distal end (136). In practice this gap should be slightly smaller than the thickness (11) of the pole (10) as shown in FIG. 10. By making the gap slightly smaller than the thickness of the pole, the clip (100) can maintain tension around the pole when the clip is installed. By slightly smaller than the thickness of the pole it is meant that the gap is in a range selected from the group consisting of between 1.0 mm and 2.5 cm smaller than the thickness of the pole, between 1.0 mm and 2.0 cm smaller than the thickness of the pole, between 1.0 mm and 1.5 cm smaller than the thickness of the pole, between 1.0 mm and 1.0 cm smaller than the thickness of the pole, between 1.0 mm and 5.0 mm smaller than the thickness of the pole, between 5.0 mm and 2.5 cm smaller than the thickness of the pole, between 5.0 mm and 2.0 cm smaller than the thickness of the pole, between 5.0 mm and 1.5 cm smaller than the thickness of the pole, between 5.0 mm and 1.0 cm smaller than the thickness of the pole, between 1.0 cm and 2.5 cm smaller than the thickness of the pole, between 1.0 cm and 2.0 cm smaller than the thickness of the pole, between 1.0 cm and 1.5 cm smaller than the thickness of the pole, between 1.5 cm and 2.0 cm smaller than the thickness of the pole, and between 2.0 cm and 2.5 cm smaller than the thickness of the pole.

In some embodiments, the second surface (112) of the plate (110) and/or the surface of the spring arm opposite the second surface of the plate may include a surface modification. The preferred surface modifications will increase the friction between the clip (100) and the flange (14) of the pole (10) when the clip is installed, thereby reducing or eliminating the likelihood that the clip will shift or fall off the pole during installation and subsequent use. Specific non-limiting examples of such a surface modification may include a burred surface, a grooved surface, a dimpled surface, and combinations thereof.

In some embodiments, the spring arm (130) may include a slot ((138) as shown in FIG. 8). When present, the slot may originate at the bowed distal end (136) of the spring arm. The slot preferably extends through the juncture between the bowed distal end and the mid-section (134) of the spring arm, and into at least a portion of the mid-section. In some embodiments, the slot may only extend into a portion of the length of the mid-section. In other embodiments, the slot may extend through the entire length of the mid-section. In some such embodiments, the slot may also extend through the juncture between the mid-section and the proximal end (132) of the spring arm, and into at least a portion of the proximal end. In some embodiments, the slot may only extend into a portion of the length of the proximal end. In other embodiments, the slot may extend through the entire length of the proximal end.

The clip disclosed herein may be manufactured of a variety of materials. Examples of such materials may include metals such as steel, stainless steel, aluminum, copper, or brass. In some embodiments, the clip may be manufactured from a plastic or composite material.

The material from which the clip (100) is manufactured will have an elasticity. One preferred material is spring steel. In this respect the clip may be thought of as a flat spring having an elastic modulus (E) in the range selected from the group consisting of between 150 to 300 GPa, between 150 and 250 GPa, between 150 and 200 GPa, between 175 and 300 GPa, between 175 and 250 GPA, between 175 and 200 GPA, between 200 and 300 GPA, and between 200 and 250 GPA. The material from which the clip is manufactured having such an elasticity allows the clip to maintain tension around the flange (14) of the pole when the clip is installed.

The material from which the clip (100) is manufactured will also have a material thickness. Preferably the material thickness will be in a range selected from the group consisting of between 0.5 mm and 2.0 mm, between 0.5 mm and 1.5 mm, between 0.5 mm and 1.0 mm, between 1.0 mm and 2.0 mm, and between 1.0 mm and 1.5 mm.

FIG. 10 shows an exploded cross-section view of a pole top (30) installation on a pole (10). As shown in FIG. 10, the pole will have a thickness (11). It is this thickness which is slightly greater than the gap ((200) as shown in FIG. 9) between the second surface ((112) as shown in FIG. 9) of the plate ((110) as shown in FIG. 9) and the bowed distal end ((136) as shown in FIG. 9)—thereby allowing the clip (100) to maintain tension around the edge of the pole.

FIG. 11 shows the assembled cross-section view of a pole top (30) installation on a pole (10) of FIG. 10. FIG. 11 shows at least one clip (100) connected to the pole (10). The pole top is shown attached to the clip(s) via fasteners (25) which pass through a hole in the pole top and attach to the threaded hole (115) in the clip. Examples of such fasteners include—but are not limited to—a bolt, a screw, or a rivet.

Using the clips disclosed herein to attach either an access cover to a pole or a pole top to a pole eliminates many of the challenges seen in the prior art. For instance, the pole and its corresponding flange may be manufactured without adding any threaded connection holes to either the flange (for connecting the access cover) or the top edge of the pole (for connecting the pole top). This also eliminates the need for post-processing repairs to the threads of the threaded connection holes after welding, galvanizing, or other processes. Instead, the clip(s) may be attached to the flange and/or the top edge of the pole after it has been installed in the field. From there the access cover and/or the pole top may be attached by simply placing the fastener(s) through holes in the respective access cover or pole, and threading them into the threaded hole of the clip.

What is claimed is:

1. A clip (100) for connecting an access cover (20) to a pole (10) comprising:
a plate (110) comprising a first surface (111), a second surface (112) opposite the first surface, a first edge (113), and a second edge (114) opposite the first edge;
a lip (120) extending from the first surface at the first edge, said lip comprising a threaded hole (125);
a spring arm (130) extending from the second surface at the second edge, said spring arm comprising:
a proximal end (132) which is attached to the second surface at the second edge,
a mid-section (134) attached to and extending from the proximal end, and
a bowed distal end (136) attached to and extending from the mid-section; and
wherein the clip is manufactured of a material having an elastic modulus (E) in a range of between 150 to 300 GPa.

2. The clip of claim 1, wherein a first juncture angle (θ₁) between the proximal end and the plate is in a range of between 80° and 100°.

3. The clip of claim 1, wherein a second juncture angle (θ₂) between the mid-section and the proximal end is in a range of between 25° and 100°.

4. The clip of claim 1, wherein a third juncture angle (θ₃) between the bowed distal end and the mid-section is in a range of between 45° and 135°.

5. The clip of claim 1, wherein a fourth juncture angle (θ₄) between the plate and the lip is in a range of between 80° and 100°.

6. The clip of claim 1, further comprising a slot (138).

7. The clip of claim 1, wherein the threaded hole is formed by applying threads directly to a hole in the lip.

8. The clip of claim 1, wherein the threaded hole is formed by placing a hole in the lip, and attaching a nut to the lip wherein a first central axis of the nut is substantially aligned with a second central access of the hole.

9. The clip of claim 1, wherein the clip comprises a first centering line (140) running through a central axis of the threaded hole substantially parallel to a length of the clip.

10. The clip of claim 1, wherein the second surface of the plate and/or a surface of the spring arm opposite the second surface of the plate comprises a surface modification.

11. The clip of claim 10, wherein the surface modification is selected from the group consisting of a burred surface, a grooved surface, a dimpled surface, and combinations thereof.

12. A clip (100) for connecting a pole top (30) to a pole (10) comprising:
a plate (110) comprising a first surface (111), a second surface (112) opposite the first surface, a first edge (113), and a second edge (114) opposite the first edge, said plate comprising a threaded hole (115);
a spring arm (130) extending from the second surface at the second edge said spring arm comprising:
a proximal end (132) which is attached to the second surface at the second edge,
a mid-section (134) attached to and extending from the proximal end, and
a bowed distal end (136) attached to and extending from the mid-section; and
wherein the clip is manufactured of a material having an elastic modulus (E) in a range of between 150 to 300 GPa.

13. The clip of claim 12, wherein a first juncture angle (θ₁) between the proximal end and the plate is in a range of between 80° and 100°.

14. The clip of claim 12, wherein a second juncture angle (θ₂) between the mid-section and the proximal end is in a range of between 25° and 100°.

15. The clip of claim 12, wherein a third juncture angle (θ₃) between the bowed distal end and the mid-section is in a range of between 45° and 135°.

16. The clip of claim 12, further comprising a slot (138).

17. The clip of claim 12, wherein the threaded hole is formed by applying threads directly to a hole in the plate.

18. The clip of claim 12, wherein the threaded hole is formed by placing a hole in the plate, and attaching a nut to the plate wherein a first central axis of the nut is substantially aligned with a second central access of the hole.

19. The clip of claim 12, wherein the second surface of the plate and/or a surface of the spring arm opposite the second surface of the plate comprises a surface modification.

20. The clip of claim 19, wherein the surface modification is selected from the group consisting of a burred surface, a grooved surface, a dimpled surface, and combinations thereof.
